(19) United States
(12) Patent Application Publication
(10) Pub. No.: US 2006/0265467 A1
(43) Pub. Date: Nov. 23, 2006

(54) P2p service method

(76) Inventor: Kyuo Jang, Seoul (KR)

Correspondence Address: LADAS & PARRY LLP, 224 SOUTH MICHIGAN AVENUE, SUITE 1600, CHICAGO, IL, 60604, US

(21) Appl. No.: 10/552,872

(22) PCT Filed: Feb. 3, 2004
(86) PCT No.: PCT/KR04/00191

§ 371 Date: Oct. 12, 2005

(30) Foreign Application Priority Data
Mar. 28, 2003 (KR) 10-2003-0019484

(51) Int. Cl. G06F 15/167; G06F 15/16

(52) U.S. Cl. 709/216; 709/218

(57) ABSTRACT

The present invention relates to a P2P service method, and more particularly, to a method of enabling paid members among users of information processors employing a P2P service to be treated preferentially and a method capable of providing other additional services. P2P service method according to the present invention is characterized by providing receiving a download request to download a predetermined file stored in a shared folder from another information processor, receiving member information including the type of a member and a holding point value held by the other information processor from the other information processor, determining, based on the member information, whether a user of the other information processor is a free member, if the user of the other information processor is the free member, comparing the holding point value to a file point value corresponding to the size of the file, and if the holding point value is larger than the file point value, transferring the file to the other information processor. According to the present invention, since P2P service companies providing a P2P service can provide a variety of services capable of preferentially treating paid members as compared to free members, conversion from free members to paid members can be induced. Thus, revenue of the P2P service companies can be assured. Further, the present invention can overcome several inconveniences caused due to the nature of the P2P during using the P2P service.

### TECHNICAL FIELD

The present invention relates to a P2P service method, and more particularly, to a method of enabling paid members among users of information processors employing a P2P service to be treated preferentially and a method capable of providing other additional services.

### BACKGROUND ART

P2P (peer-to-peer) refers to a communication model in which respective computers have equivalent capability so that any computer can initiate a communication session. P2P is also called equivalent layer communication, which means that all information processors connected over communication networks are allowed to share data, peripheral devices, and the like at an equivalent level.

In an existing client/server model, an information processor (corresponding to a client), which desires to receive given data, requests the data to a server, and the server searches for the data from a given database to send the data to the information processor.

Unlike the client/server model, each information processor (corresponding to a client) in P2P can search for data stored in other information processors and then directly connect to the other information processor to receive the data. That is, each information processor functions as both a server and a client.

Due to advantages of P2P wherein data stored in personal information processors having no server can be shared, service companies for providing P2P-related services as well as users who desire to employ P2P-related service are increasing.

Generally, P2P service companies provide application programs enabling a service of the company to be employed and users who desire to share information using P2P will install to their information processors a given application program for performing P2P, in which the users commonly designate their shared folder in application program installation. The “shared folder” corresponds to a folder that stores data to be provided to other information processors through P2P, and the other information processors are allowed to search for only data stored in the shared folder.

In addition to providing the application programs, the P2P service companies perform member management and provide a search function of searching for information processors of which the connections have been established and of searching for files stored in shared folders of the information processors.

Meanwhile, as the sharing of files through P2P is activated, several problems arise and thus there is an increasing need for overcoming these problems.

First, there is a problem in that it is difficult for service companies, which have P2P operating servers and provide a P2P service, to obtain revenue because file transmission is made between information processors. That is, there is a problem in that, even though the service company operates a P2P server, makes and manages information on information processors connected to the P2P operating server and information on users into a database, and provides various additional services, it is difficult to find a step suitable for charging the users of the information processors connected to the P2P operating server because the transfer of files that information processor users transmit and receive is not made via the P2P operating server but directly between the information processors. Consequently, there is a need for creating revenue by providing a P2P service in distinction with existing P2P service companies.

Second, unlike the server/client model, because subjects transmitting files and subjects receiving files are information processors corresponding to respective peers, and most of the information processors commonly are personal computers owned by persons, processing capacities of respective information processors are significantly smaller as compared to servers in the server/client model. Thus, there was a problem of inconvenience when using P2P, such as limitation in the number of information processors allowed to connect to one information processor while assuring some processing speed, limitation of the time during which information processors are allowed to connect to other processors since the other information processors do not maintain their connection for twenty hours, or the like.

### DISCLOSURE OF INVENTION

The present invention is conceived to solve the aforementioned problems in the prior art. An object of the present invention is to assure revenue of P2P service companies by distinguishing members accepting a P2P service into paid members and free members and providing preferential service to the paid members.

In addition, with the present invention, it is possible to transmit and receive files between information processors when connection times of respective information processors are different from each other.

Further, according to the present invention, it is possible to transmit and receive files between remote information processors by connecting to a P2P operating server using a mobile communication terminal.

In addition, with the present invention, it is possible to offer a P2P service interlocked with the community using information on the information processors subscribed to respective communities.

Further, with the present invention, it is possible to transmit and receive files to and from an information processor to which a direct connection is not allowed due to the existence of a firewall or the like, using a relay information processor.

The term “shared folder” used herein means an object that stores files that may be shared with other information processors among information processors. Further, the term “shared information processor” means an information processor that transmits files to other information processors through P2P. Further, the term “collecting information processor” means an information processor that receives files from other information processors through P2P. In P2P, an information processor may be simultaneously both a shared information processor (functioning as a server) and a collecting information processor (functioning as a client).

The term “point” used herein is offered from a P2P server according to the present invention and is a unit having a predetermined value. It has a concept that includes cyber money or cyber items capable of being used as exchange means upon accepting a certain service. Such points can be offered in a variety of manners, such as obtaining points by paying cash or through a predetermined mileage system.

### BRIEF DESCRIPTION OF DRAWINGS

FIG. 1 is a block diagram illustrating information processors that may be employed in a P2P service method according to the present invention.

FIG. 2 is a diagram showing an example of an input window of the connection module to connect to the P2P server.

FIG. 3 is a flowchart illustrating a P2P service method according to an embodiment of the present invention.

FIG. 4 is a flowchart illustrating a P2P service method according to another embodiment of the present invention.

FIG. 5 is a flowchart illustrating the P2P service method according to another embodiment of the present invention.

FIG. 6 is an examplary diagram illustrating a physical environment in which the P2P service method is performed.

FIG. 7 is a flowchart illustrating the P2P service method according to another embodiment of the present invention.

FIG. 8 is a flowchart illustrating a P2P service method according to another embodiment of the present invention.

FIG. 9 is a diagram showing an example of a screen displayed on the information processor according to the P2P service method.

FIG. 10 is a diagram showing an example of a physical environment in which the P2P service method is performed.

FIG. 11 is a flowchart illustrating the P2P service method according to another embodiment of the present invention.

FIG. 12 is a block diagram showing a P2P service system according to another embodiment of the present invention.

FIG. 13 shows an example of the case that folders corresponding to a 19-years-or-older age limit category are displayed on an information processor in a P2P service system according to another embodiment of the present invention.

### BEST MODE FOR CARRYING OUT THE INVENTION

Hereinafter, preferred embodiments of the present invention will be described in detail with reference to the accompanying drawings.

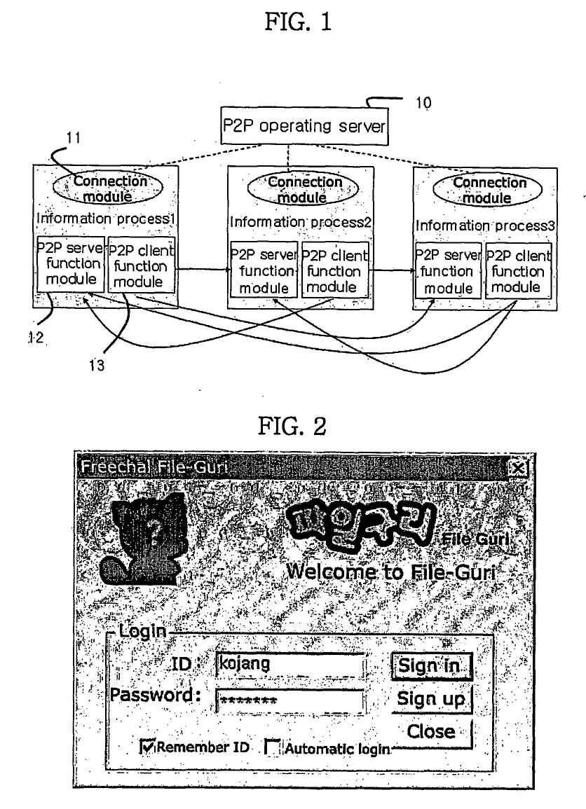

FIG. 1 is a block diagram illustrating information processors that may be employed in a P2P service method according to the present invention. Each of the information processors 1, 2 and 3 includes a connection module 11 for connecting to a P2P server 10, a P2P server function module 12 for performing a function of the P2P server, and a P2P client function module 13. Arrows, used in FIG. 1, indicate all cases where each information processor may connect to other information processors. Each of the modules 11, 12 and 13 may be created by installing a given application program. The application program may be provided from the P2P server or a separate server.

FIG. 2 is a diagram showing an example of an input window of the connection module 11 allowing the information processor to connect to the P2P server 10 using the application program. If a user inputs his/her ID and password and requests a connection to the P2P server 10 according to an indication of the input window, connectivity information including an IP address and port information of the information processor, and member information, such as the ID and password of the user of the information processor, can be sent to the P2P server 10 and be stored in a given database.

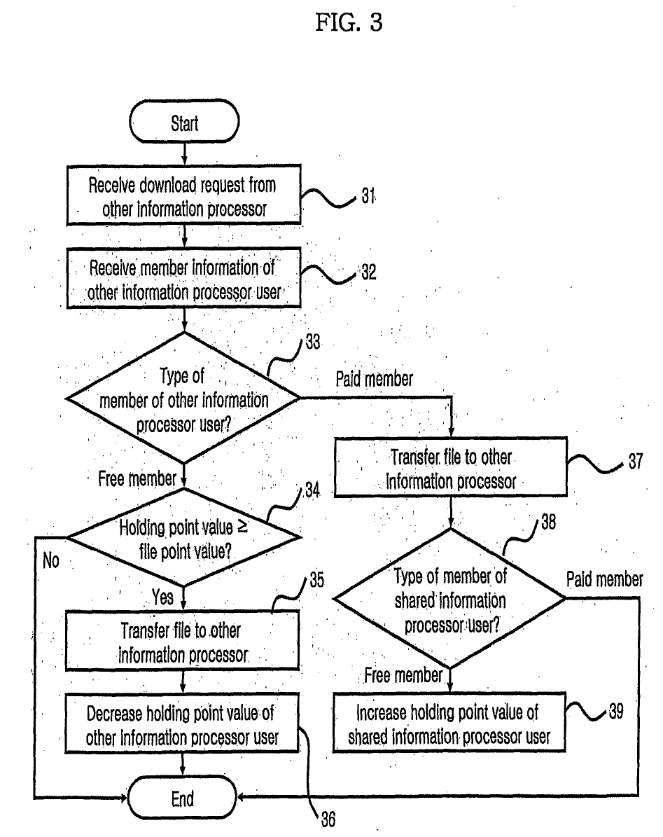

FIG. 3 is a flowchart illustrating a P2P service method 30 according to a first embodiment of the present invention. The P2P service method 30 according to this embodiment is performed at a shared information processor stage that transmits files.

In step 31, a shared information processor, which shares predetermined files stored in a shared folder with other information processors, receives a download request for the files from other information processors.

The shared information processor, which has received the download request, receives member information including the type of members of the other information processors and point values held by the other information processors, in step 32. The type of members may be generally classified into free members and paid members. Determination as to whether a member is a paid member or a free member may be made in the process of performing member subscription to a P2P service company for providing a P2P service and of establishing a connection to a P2P server. If a given member is a free member, the free member may become a paid member by such a procedure as paying a predetermined service charge, and a paid member may become a free member by failing to meet predetermined requirements.

In step 33, the shared information processor determines, based on the received member information, the type of a member as to whether the user of the other information processor is a free member or a paid member.

If the other information processor user is determined to be a free member, the shared information processor compares the holding point value to a file point value based on the member information, in step 34. The file point value indicates a value replaced in a predetermined ratio from the size of a file that another information processor desires to download. For example, if the size of the file is 1 Mbyte, the point value of the file may be set to 1. In this case, if 2 Mbyte is replaced into a file point value in the same ratio, it corresponds to 2 points. That is, another information processor desiring to download a file having a size of 2,500 Kbytes must hold 2.5 points.

Further, according to another embodiment of the present invention, 500 Kbytes corresponds to 0.5 points but fractional values may be excluded for convenience of storage and management. In this case, when downloading a file having a size of 2500 Kbytes as described above, the necessary holding point value is rounded down to 2 points.

In step 34, if the holding point value is more than the file point value as a result of comparing the holding point value to the file point value, the file transfer is made from the shared information processor to the other information processors.

If the file transfer to the other information processors is successfully completed, the shared information processor sends the member information and the file point value to the P2P server. The P2P server identifies the other information processor using the member information, and decreases the holding point value, which is being stored in the information processor database and corresponds to the other information processor user, by the file point value (step 36).

If the holding point value is less than the file point value as a result of comparing the holding point value to the file point value in step 34, the other information processor will fail to download the file from the shared information processor and all steps will end.

Further, if the other information processor user is determined to be a paid member in step 33, the shared information processor transfers the file to the other information processor (step 37). At this time, the holding point value corresponding to the other information processor user is not decreased, which may be a preferential service for paid members.

If the file is transferred to the other information processor and the file transfer is completed in step 37, determination is made as to the type of a member of the shared information processor user, which comprises the shared folder and provides the files stored in the shared folder, in step 38. If the user of the shared information processor is determined to be a free member, a control signal is generated to increase its holding point value, which is stored in the information processor database and corresponds to the user of the shared information processor, by the file point value, in step 39. When receiving the control signal, the P2P server increases the holding point value, which is stored in the information processor database and corresponds to the user of the shared information processor, by the file point value.

With the configuration like above, it is possible for a free member to increase its holding points by providing a file stored in his/her information processor to other information processors.

If it is determined in step 38 that the shared information processor user is a paid member, it corresponds to the file sharing between the paid members, and thus, there are no changes in the points held by the user of the other information processor and the points held by the user of the shared information processor.

In the aforementioned P2P service method 30, the change in the points that the other information processor user and the shared information processor user hold respectively is shown in Table 1 below.

TABLE 1

| User of another | User of shared | |
|---|---|---|
| information | information | |
| processor | processor | Point value after download |
| Paid member | Paid member | Not changed |
| | Free member | Increase holding point value of |
| | | shared information processor user |
| Free member | Paid member | Decrease holding point value of |
| | Free member | another information processor user |

As shown in Table 1, if a free member downloads a file from a shared information processor, his/her holding point value is decreased regardless of the type of membership of the shared information processor user. If a paid member downloads a file from a shared information processor, there is no change in his/her holding point value regardless the type of membership of the shared information processor user but, if the free member provides files to the paid member, it results in an increase of the holding point value of the free member. Thus, it is possible for free members to increase their points.

There is no change of the point value the paid member holds even though the paid member downloads files from other information processors while the point value the free member holds decreases in proportion to the size of the downloaded file whenever the free member downloads a file after connecting to a shared information processor. As a result, free members are not allowed to download files when they have insufficient holding points. Thus, since there is no method capable of accumulating points for free members (in this embodiment, the point value held by free members may be increased if a paid member connects to the information processor of the free member to download files, but this method belongs to a passive method from a point of view of the free member), the free member will want to become a paid member when the free member wants a successive P2P service according to this embodiment. Thus, using the P2P service method according to this embodiment could induce the conversion of users from free members to paid members, which helps improve service companies' revenue.

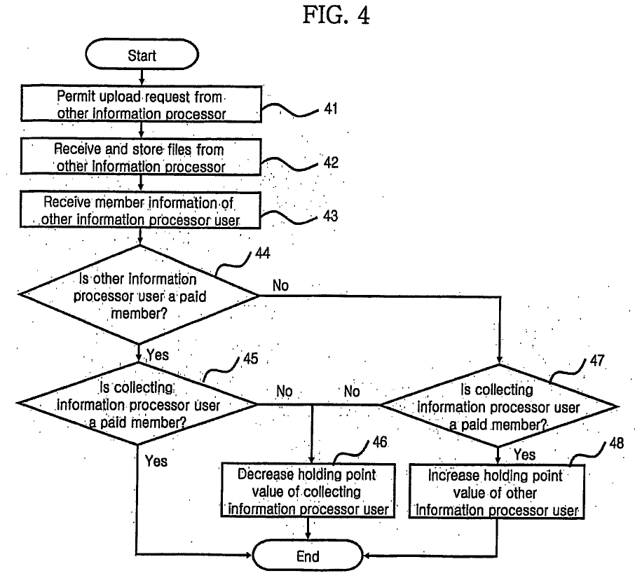

Hereinafter, a P2P service method 40 according to a second embodiment of the present invention will be discussed. FIG. 4 is a flowchart illustrating a P2P service method 40. The P2P service method 30 according to the first embodiment is characterized by the change of points each user holds due to files downloaded while the P2P service method 40 according to this embodiment is characterized by the change of points each user holds in files uploaded. The P2P service method 40 according to this embodiment is achieved at a collecting information processor stage.

In step 41, the user of a collecting information processor receives an upload request from the collecting folder of the collecting information processor with respect to a predetermined file from another information processor and accepts the request (the collecting folder and the shared folder may be physically the same objects). According to another embodiment of the present invention, the user of the collecting information processor, receiving the upload request to upload the file, receives information on the file and may reject upload of the file according to the information.

When the upload request is permitted, the file from another information processor is received and stored in the collecting folder in step 42. Through steps 41 and 42, the upload to the collecting information processor is completed, and the management is made in the subsequent steps as to the points held by the user of the collecting information processor and the user of the other information processor.

In step 43, the collecting information processor receives member information that includes the type of membership and holding point values held by other information processors from the other information processor. In step 44, the collecting information processor determines, based on the member information, the type of a member as to whether the user of the other information processor is a paid member or a free member.

If the user of the other information processor is determined to be a paid member, the type of a member of the user of the collecting information processor is determined in step 45. If the user of the collecting information processor is determined to be a paid member in step 45, all processes end regardless of point values held by the user of another information processor and the user of the collecting information processor. That is, there is no variance according to file upload between paid members.

If it is determined in step 45 that the user of the collecting information processor is a free member, the collecting information processor generates a control signal to decrease a holding point value, which corresponds to the user of the collecting information processor, by a file point value corresponding to the uploaded file. If the P2P server receives the control signal, it decreases the user's holding points, which are stored in the information processor database and corresponds to a holding point value corresponding to the user of the collecting information processor, by a file point value. That is, if the free member receives a file uploaded from the information processor of a paid member, the point value held by the free member decreases.

If it is determined in step 44 that the user of the other information processor is a free member, the member type of the user of the collecting information processor is determined in step 47. If the user of the collecting information processor is determined to be paid member, the collecting information processor generates a control signal to increase the holding point value held by the user of the other information processor by a file point value corresponding to the uploaded file. If the P2P server receives the control signal, it increases a user's holding point value, which is stored in the information processor database and corresponds to the user of the other information processor, by a file point value. That is, if a free member receives a predetermined file uploaded from the information processor of a paid member, the point value held by the free member will increase.

If it is determined in step 47 that the user of the collecting information processor is a free member, in step 46, the collecting information processor generates a control signal to decrease the holding point value held by the collecting information processor by a file point value corresponding to the uploaded file. That is, when a free member receives a predetermined file uploaded from an information processor of another free member, the point value held by the uploading free member is decreased.

The change of points held by the user of the collecting information processor and the user of another information processor in the P2P service method 40 according to this embodiment as described above is shown in Table 2 below.

TABLE 2

| | User of | |
|---|---|---|
| User of another | collecting | |
| information | information | |
| processor | processor | Point value after upload |
| Paid member | Paid member | Not changed |
| | Free member | Decrease the holding point value of the |
| | | user of collecting information processor |
| Free member | Paid member | Increase the holding point value of the |
| | | user of another information processor |
| | Free member | Decrease the holding point value of the |
| | | user of collecting information processor |

As shown in Table 2, the P2P service method 40 according to this embodiment is configured so that, if a free member receives a predetermined uploaded file of another information processor, the holding point value held by the free member decreases regardless of whether the user of another information processor is a paid member or a free member. Consequently, in connection with the P2P service method 30, there is a constraint that, in order for a free member to receive an uploaded file or download a file, his/her holding point value should be equal to or greater than the file point value that corresponds to the size of desired files. Conversion from a free member to a paid member can be induced due to such constraints.

On the other hand, the P2P service method 40 according to this embodiment provides a method capable of increasing the holding point value held by free members if the free member uploads a predetermined file to an information processor of a paid member, which allows the free member to positively increase his/her held point value. With such a configuration, promoting free members to upload files and inducing file upload between information processors can activate the P2P service.

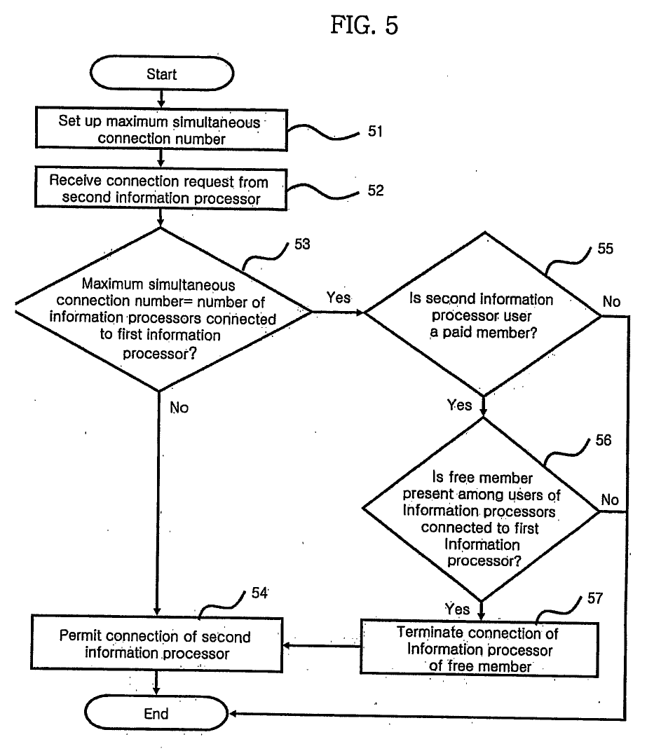

Hereinafter, a P2P service method 50 according to a third embodiment of the present invention will be discussed. FIG. 5 is a flowchart illustrating the P2P service method 50. The P2P service method 50 according to this embodiment is performed in a first information processor stage.

The maximum simultaneous connection number of information processors that can be simultaneously connected to a first information processor is set up in step 51. It is frequent for a user who shares information using a P2P service to limit the number of information processors connected to the user's information processor. Generally, since most of information processors used in the P2P are personal PCs, it easily occurs that task speed is significantly degraded due to insufficient PC specification or the like if a number of information processors simultaneously connect to a PC to perform file uploads, file downloads or the like. Thus, the user of an information processor desires to solve such a problem by setting the maximum simultaneous connection number suitable for the capacity of the user's information processor.

However, it is impossible for a user, who desires to connect to an information processor of which the maximum simultaneous connection number has been set up, to connect to such an information processor and it is difficult to recognize when the user is allowed to connect to the information processor if other information processors have been already connected thereto by the maximum simultaneous connection number. In this case, with this embodiment P2P service method 50 according to this embodiment, it is possible to solve somewhat the aforementioned problem by preferentially treating paid members to preferentially give a connection chance to an information processor of which the maximum simultaneous connection number has been set up and, at the same time, to induce conversion from free membership to paid membership. The P2P service method 50 will be discussed in more detail in steps 52 to 57.

In step 52, a first information processor receives a connection request from a second information processor. When receiving a connection request, the first information processor determines whether the number of information processors connected to the first information processor matches the maximum simultaneous connection number, in step 53.

If the numbers are determined not to match, namely, if the number of the information processors connected to the first information processor is less than the maximum simultaneous connection number, the connection of the second information processor is permitted in step 54. This is because the maximum simultaneous connection number has not yet been reached and thus the second information processor is allowed to be connected additionally.

If the numbers are determined in step 53 to match, namely, if the number of the information processors connected to the first information processor corresponds to the maximum simultaneous connection number, discrimination is made in step 55 as to whether the user of the second information processor is a paid member. If the user of the second information processor is determined to be a free member, the connection of the second information processor to the first information processor is not permitted and all steps end.

If it is determined in step 55 that the user of the second information processor is a paid member, determination is made as to whether a free member is contained among the users of information processors connected to the first information processor in step 56. If there is no free member among the users of the information processors connected to the first information processor, namely, all of the users are paid members, the connection of the second information processor to the first information processor is not permitted and all steps end. It is preferable that there is no priority in providing a P2P service between paid members, but connections of first connected paid members are maintained and the connections of paid members requesting subsequent connections are not permitted.

If it is determined in step 56 that a free member exists among the users of the information processors connected to the first information processor, the connection of the information processor of the free member is terminated in step 57 while the connection of the second information processor to the first information processor is permitted in step 54. That is, with the P2P service method 50 according to this embodiment, if information processors corresponding to the maximum simultaneous connection number have been already connected to the first information processor and a free member is contained among the users of the connected information processors, an information processor of a paid member requesting later a connection is allowed to be connected even though the information processor of the free member has been first connected. Thus, it is possible to improve a service for paid members by permitting paid members to be preferentially connected.

If the type of membership is not divided to both paid members and free members but is divided into a variety of classes, the configuration of each step in the aforementioned P2P service method 50 may be modified a little. Hereinafter, a variant of this embodiment that may be employed when there are three types of member class, such as normal members, preferential members, and special members, and the provision of improved service to higher classes of members will be discussed.

In the P2P service method in which three or more types of membership exist, the same steps as the aforementioned steps 51 to 54 are performed. At this time, in step 53, if the maximum simultaneous connection number matches the number of information processors connected to the first information processor, identification is made as to member class information of users of the information processors connected to the first information processor and the second information processor requesting a connection.

If it is identified that there exists a lower order user having a lower member class than that of the user of the second information processor among the users of the information processors connected to the first information processor, the connection of the information processor of the lower order user is terminated while the connection of the second information processor is permitted. With this configuration, it is possible to provide an improved P2P service to users having a higher membership class. If it is identified that there is no lower order user having the lower member class than that of the user of the second information processor, the connection request of the second information processor is rejected and the connection thereto is not permitted.

Meanwhile, according to a further embodiment of the present invention, the method may further include the step of, if it is identified that there are a plurality of lower order users, terminating the connection of an information processor of the lowest order user having the lowest membership class among the lower order users.

Further, according to a still further embodiment of the present invention, the method may include the step of, if there are a plurality of lowest order users having the same membership class, discriminating the last connected information processor among information processors of the lowest order users, and blocking a connection of the last connected information processor.

The term “the lowest order user” used in this embodiment refers to a user having the lowest class among users connected to the information processor rather than a user having the lowest class among member classes designated by a P2P service company.

With the aforementioned configuration, it is possible to provide reasonable criterion as to whether to terminate an information processor of a lower order user when there are a plurality of lower order users having the same condition.

According to a still further embodiment of the present invention, an information processor user may register users of other information processors as preferential members or delinquent members in connection with a usage right for files shared by the user. In the P2P service method according to this embodiment, a paid member may be automatically registered as a preferential member regardless of whether the information processor user has been registered. The preferential member may have priority when it is connected to an information processor having the set maximum simultaneous connection number as described above. On the other hand, the connection of a user registered as a delinquent member to the information processor is blocked regardless of the maximum simultaneous connection number (accordingly, the user can not download the files stored in the shared folder of the information processor). Further, it is possible for the information processor user to cause the files shared by the information processor user not to be searched by the delinquent member. Further, if a service company provides, along with the P2P service, so-called a short message service that transfers a short message in real time between users connected to the P2P server, the short messages from a delinquent member may be blocked.

Further, according to still another embodiment of the present invention, it is possible to make delinquent or preferential member registrations with respect to an individual user meeting a predetermined condition, for example, to register a delinquent member or a preferential member on the basis of an individual user (i.e., ID) of an information processor, and in the case of providing a P2P service interlocking with a community service as described below, to make delinquent member registration or preferential member registration on a community-by-community basis. That is, when a user has been subscribed to a community of “animation mania,” it is possible to collectively register users belonging to the animation mania community as preferential members.

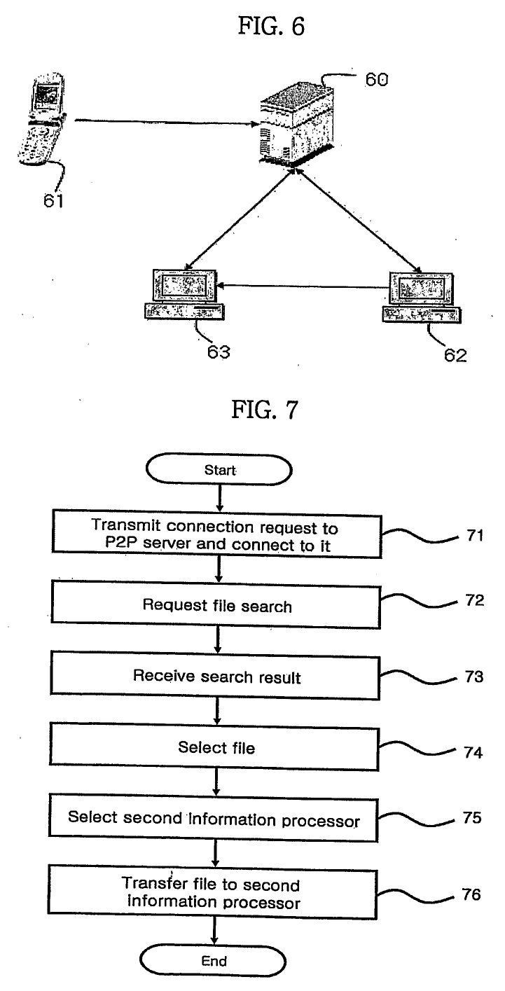

Hereinafter, a P2P service method 70 according to a fourth embodiment of the present invention will be discussed. The P2P service method 70 according to this embodiment is characterized by providing a P2P service using a mobile communication terminal. FIG. 6 is a diagram illustrating a physical environment in which the P2P service method 70 is performed, and FIG. 7 is a flowchart illustrating the P2P service method 70.

As shown in FIG. 6, reference numeral 60 denotes a P2P server, reference numeral 61 denotes a mobile communication terminal connected to the P2P server 60, and reference numerals 62 and 63 indicate information processors connected to the P2P server.

In step 71, the mobile communication terminal 61 transmits a connection request to the P2P server 60 over a communication network and connects to the P2P server 60. In step 72, the mobile communication terminal 61 transmits a search request to search for files stored in a shared folder of an information processor of which the connection is established to the P2P server 60, and receives the search result from the P2P server 60 in step 73.

The mobile communication terminal 61 selects files among files contained in the search result in step 74 (at this time, the information processor storing the files in the shared folder is referred to as “first information processor 62”) and selects the second information processor 63 to which the selected files will be transferred in step 75. If the mobile communication terminal 61 selects the files and the second information processor 63 and sends the selection result to the P2P server 60, the P2P server 60 makes the selected files to be sent from the first information processor 62 to the second information processor 63 in step 76.

With such a configuration, even when a mobile communication terminal user is positioned at a position remote from an information processor such as PC (or other's information processor selected by the user), the user can cause files to be downloaded to the information processor using the mobile communication terminal. On the contrary, if the first information processor is the user's information processor, the user can cause files to be uploaded to the second information processor using the mobile communication terminal. Thus, with the P2P service method 70 according to this embodiment, it is possible to instruct file download and upload from a remote position through the P2P using a mobile communication terminal having excellent portability, which allows the user to receive enhanced P2P service.

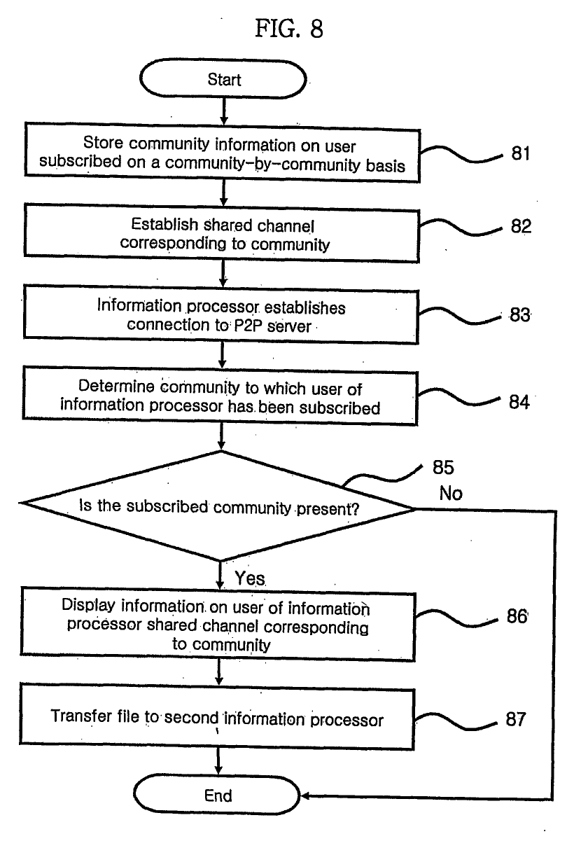

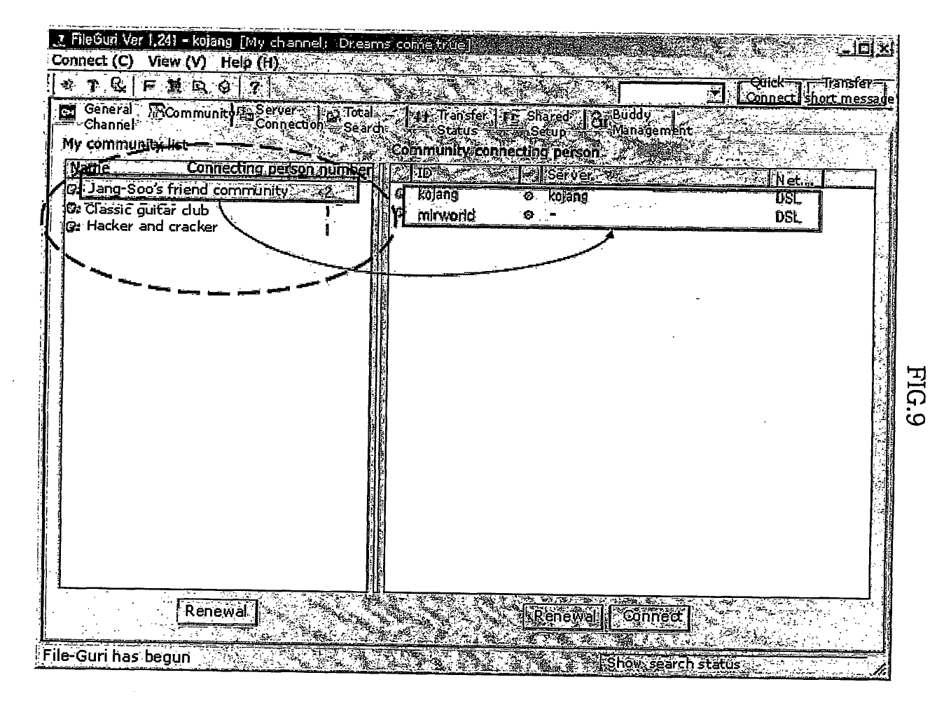

Hereinafter, a P2P service method 80 according to a fifth embodiment of the present invention will be discussed. The P2P service method 80 according to this embodiment is characterized in that it can interlock with a community service to provide a P2P service. FIG. 8 is a flowchart illustrating a P2P service method 80, and FIG. 9 is a diagram showing an example of a screen displayed on the information processor according to the P2P service method 80.

In step 81, the community server stores community information on users subscribed on a community-by-community basis in a predetermined database. In step 82, the P2P server establishes shared channels corresponding to the communities, respectively, and makes the shared channels to be displayed on information processors connected to the P2P server.

The “shared channel” employed in this embodiment is a kind of service provided from the P2P server so that users of the information processors connected to the P2P server may easily perform a search or the like. For example, if the title of the shared channel is designated as “animation mania”, a user storing a number of animations in the shared folder of the information processor (or a user who is very interested in animation) can make an application so that the information processor of the user is displayed in the shared channel designated as “animation mania.” At this time, a user desiring to download or upload an animation file can preferentially search for the information processor displayed in the shared channel designated as “animation mania” so that those desired are easily obtained. At this time, one information processor may be displayed in one or more shared channels. The user of the information processor storing a number of animation files and Japanese music files may make an application so that his/her information processor is displayed in the shared channels designated as “animation mania” and “All Japanese music collection” among formed shared channels.

Further, according to a still further embodiment of the present invention, it will be possible to create a new shared folder by a user of the information processor selecting the title of a new shared channel.

Meanwhile, the term “community” used herein refers to a service providing an activity space where users create and shared information online, or a space created by such a service. According to the aforementioned configuration, the P2P service method 80 may automatically establish a shared channel corresponding to a community and provide the formed channel to an information processor connecting to the P2P server.

In step 83, the information processor establishes a connection with a P2P server. At this time, discrimination is made in step 84 as to which community the user of the information processor is subscribed on the basis of the community information.

If the subscribed community is discriminated to be present, information on the user of the information processor is displayed in a shared channel corresponding to the community to which the user of the information processor is subscribed, in step 86.

FIG. 9 is a diagram illustrating the result that has been displayed in step 86. A left frame on a screen shows formed and displayed shared folders each corresponding to communities of “Jang-Soo's friend community,” “classic guitar club,” “hacker and cracker,” and a right frame on the screen displays information on information processor users subscribed to “Jang-Soo's friend community” among the shared folders.

In the example shown in FIG. 9, only connections of two users' information processors of “Jang-Soo's friend community” have been established. If a user subscribed to “Jang-Soo's friend community” newly establishes a connection to the P2P server, information on the user will also be automatically displayed in “Jang-Soo's friend community” shared channel.

Thus, by providing the interlocked community and P2P services, it is possible to share information more conveniently between community users having similar concerns and to provide more chances for contact between users subscribed to the community. Further, there is an advantage in that although the community service and the P2P service are separate services, a P2P service company simultaneously providing the community and P2P services or a P2P service company desiring to provide a P2P service by cooperating with other service companies providing the community service can provide an enhanced service to users using the P2P service method 80.

Hereinafter, a P2P service method 1100 according to a sixth embodiment of the present invention will be discussed. The P2P service method 1100 according to this embodiment is characterized in that file transmission and reception between a first information processor and a second information processor is not performed in a direct manner but through a relay information processor which is a third information processor.

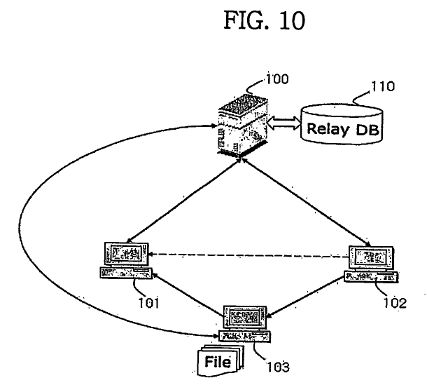

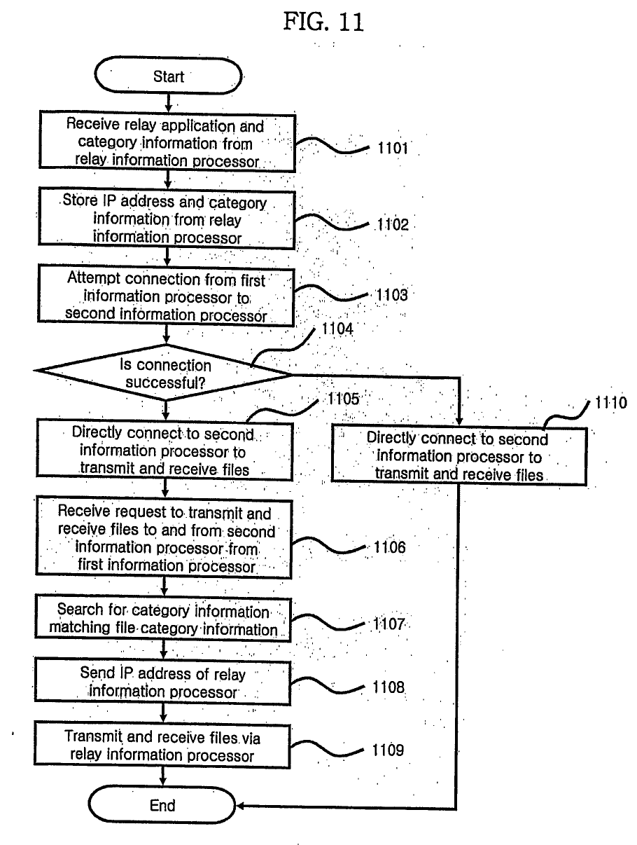

FIG. 10 is a diagram showing an example of a physical environment in which the P2P service method 1100 is performed and FIG. 11 is a flowchart illustrating the P2P service method 1100.

The information processor sends an IP address and port information of the information processor to a P2P server 100 and establishes a connection with the P2P server 100. However, there is a problem in that if the information processor is using a shared IP or a firewall is built in the information processor, another information processor cannot directly connect to such an information processor and thus file transmission and reception using P2P cannot be realized.

In the P2P service method 100 according to this embodiment, the concept of a relay information processor is introduced to solve the aforementioned problem. The relay information processor performs a function of receiving a file from one of two other information processors and transmitting the file to the other information processor, which makes transmission and reception between information processors of which the direct connection is not allowed due to the existence of the firewall or the like possible.

The P2P service method 100 according to this embodiment can be applied to all information processors in which a connection to another information processor is permitted but a connection from the another information processor is blocked (such a case is represented as blocking of a direct connection to an information processor), such as an information processor using a shared IP, an information processor in which an firewall is built, and the like.

Meanwhile, methods in which if a firewall is built transmission and reception of files is made through bypass of the firewall are described in application specifications of Korean Patent Application Nos. 10-2000-0077563 and 10-2001-0008055. The aforementioned inventions are similar to the P2P service method 1100 in accordance with this embodiment in that a relay information processor is employed. However, the application inventions are different from the P2P service method 1100 described below in a configuration in that files relayed in a third information processor corresponding to the relay information processor of this embodiment are not stored but deleted, that a P2P server recognizes whether a firewall is present in an information processor (a method for recognizing whether the firewall is present is not described in detail) so that a third information processor is immediately employed, and that the type of files relayed by a third information processor are not specific. On the other hand, the P2P service method 1100 according to this embodiment may be applied when a direct connection at one information processor side is blocked as well as when direct connections at both information processors desiring to transmit and receive files are not allowed.

P2P service method 1100 will be discussed in more detail with reference to FIG. 11. In step 1101, the P2P server 100 receives a relay request to relay file transmission and reception between information processors, and category information from a relay information processor 103. In step 1102, the P2P server 100 stores an IP address corresponding to the relay information processor 103 and the category information in the relay database 110.

Meanwhile, although not shown in FIG. 11, a still further embodiment of the present invention may include the step of determining whether a direct connection of the P2P server 100 to the relay information processor 103 is permitted, based on the IP address and port information of the relay information processor 103. Through such a process, only an information processor capable of relaying file transmission and reception can be set up as a relay information processor.

In step 1103, the first information processor 101 attempts a direct connection to the second information processor 102. This is intended to test whether direct connection to the information processor is permitted while considering several cases such as change of the connection state or the transmission of erroneous information, even though information on whether the direct connection to the information processor is permitted may be sent to the P2P server 100 at the step of establishing a connection with the P2P server 100. However, it will be preferable to set up a response waiting time after requesting direct connection to be shorter in the case where the information processor sends to the P2P server 100 the information indicating that the direct connection is not permitted.

If the direct connection attempt is successful, the first information processor 101 directly connects to the second information processor 102 to transmit and receive files without using the relay information processor in step 1110.

On the contrary, if the direct connection attempt fails, the first information processor 101 requests to the P2P server 100 file transmission and reception to and from the second information processor 102 and then transmits file category information together, which corresponds to information on the category to which files to be transmitted and received to and from the second information processor belong (steps 1105 and 1106). In step 1107, the P2P server 100 searches for category information matching the file category information from the relay database 110 in response to the request. In step 1108, the P2P server 100 sends an IP address of the relay information processor 103 corresponding to the searched category information to the first information processor 101 and the second information processor 102.

According to a still further embodiment of the present invention, if category information matching to the file category information is not searched, similar category information is stored together in the relay database depending on the similar degree between the category information, and an IP address of the relay information processor corresponding to the similar category information is sent.

In step 1109, if the second information processor 102 directly connects to the relay information processor 103 using the IP address of the relay information processor 103 and transmits files to the relay information processor 103, then the relay information processor 103 stores the files in the shared folder. The first information processor 101 also directly connects to the relay information processor 103 using the IP address of the relay information processor 103 and receives the files stored in the relay information processor 103 (on the contrary, the first information processor may transmit files and the second information processor may receive the files.)

At this time, with the P2P service method 1100 according to this embodiment, file transmission and reception between the information processors 101 and 102 of which the direct connection is blocked becomes possible. At the same time, there is an advantage that since the relay information processor 103 is configured so that files belonging to the category set up by the relay information processor are automatically stored in the shared folder of the relay information processor 103, the user of the relay information processor 103 can collect a desired kind of files without separate efforts.

Further, the present invention can provide a computer-readable recording medium on which a program for implementing the aforementioned P2P service method according to the first to sixth embodiments on a computer is recorded.

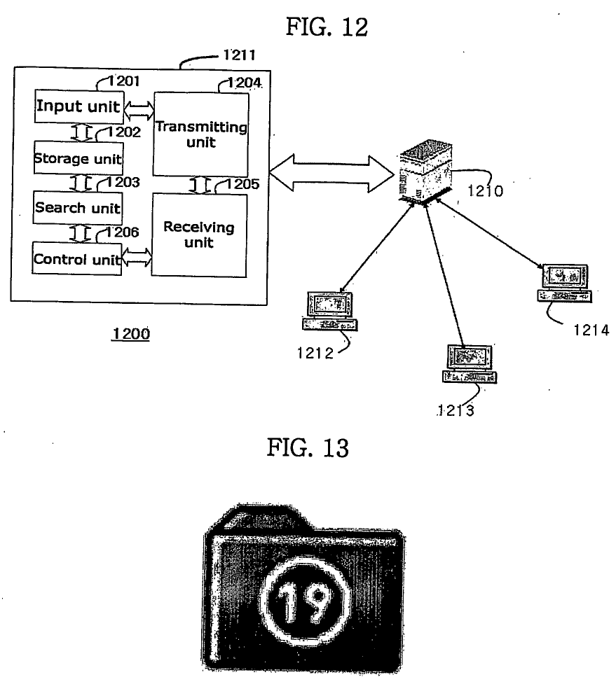

A P2P service system 1200 according to a seventh embodiment of the present invention will be discussed. FIG. 12 is a block diagram showing a P2P service system 1200. In FIG. 12, reference numeral 1210 denotes a P2P server and reference numerals 1211, 1212, 1213 and 1214 denote information processors connected to the P2P server. A P2P service system 1200 includes an input unit 1201, a storage unit 1202, a search unit 1203, and a transmitting unit 1204

If a user of an information processor registers a given folder in a shared folder to share files stored in the folder with a user of another information processor, an input unit 1201 receives one or more categories corresponding to the folder.

For example, when desiring a new folder in the shared folder, a P2P service system 1200 can provide a category list to allow an information processor user to select a category corresponding to the folder. The category may contain information on the contents of the files, such as movies, music, or the like, and a variety of detailed categories may be set, such as Hollywood movies, Hong-Kong movies, horror movies, romantic comedies, or the like according to embodiments. Further, the category may be an age limit category for setting up an age suitable for using the files stored in the folder, such as infants, a 19-years-or-older age limit category, and the like. The type of category may be modified and varied by updating (via online or offline) an application program, which is installed in the processor to provide the P2P service according to this embodiment.

The storage unit 1202 stores the folder and one or more categories corresponding to the folder (more exactly, category information that can distinguish the category).

First, a configuration for sending a search result to the folder stored in the shared folder of the information processor in response to a request from another information processor (or the P2P server) will be discussed.

In the case of transmitting and receiving files in a P2P manner, manners of sequentially connecting to other information processors and searching for files (or folders) stored in shared folders of the information processors includes a variety of methods such as Gnutela's method, a method in which a website SoriBada is recently performing using a super peer, and the like. The existence or non-existence of a P2P server may depend on each of these methods.

A case where a subject that requests a search for the information processor is a P2P server will be discussed in this embodiment, even though the P2P service system 1200 according to this embodiment may be employed in a variety of search systems including the aforementioned respective methods. According to still another embodiment of the present invention, a subject requesting to search for files, stored in a shared folder of an information processor, may be another information processor directly connected to the information processor, and the P2P server may be understood as being included in another information processor.

The user of another information processor 1212 requests the P2P server 1210 to search folders corresponding to a predetermined category, and in turn the P2P server sends the search request to each of the connected information processors 1211, 1213 and 1214 in response to the search request.

When receiving the search request for a search for folders corresponding to the predetermined category from the P2P server 1201, the search unit 1203 searches for folders stored in the storage unit 1202 and corresponding to the predetermined category. The transmitting unit 1204 sends a list of the searched folders to the P2P server 1210, and the P2P server 1210 receiving the list of the searched folders from each of the information processors 1211, 1213, and 1214 sends the searched folder list to the information processor 1212 requesting the search. Thus, a search for each of the information processors is performed.

According to this embodiment in which a category is set up to each folder, the folder is registered in a shared folder, and a search is performed based on the category as described above, since the search unit 1203 needs to find only folders corresponding to the requested category and provide a list of folders corresponding to the category to the transmitting unit 1204, it is unnecessary to discriminate information such as the title of folders or the like, thereby significantly reducing the time consumed for a search.

Further, a user of another information processor requesting a folder search is also allowed to search for desired files even without knowing detailed information such as the file name, or the like, thereby improving the search service. That is, in a case of music files, even though one does not know the titles of songs or singers exactly, it is possible to receive a list of folders searched by performing the search on a category-by-category basis, such as “Japanese music,” “jazz” or the like, to search for desired files among the folders in the list, and to download the files.

It is preferable that a user stores, in a folder of which the category is set up and which is registered by the user, only files belonging to the category of the folder in order to increase the accuracy of the search according to the P2P service system 1200. Further, it is possible for one or more categories to be corresponded to one folder. That is, three categories of “animation,” “19-years-or-older” and “mass capacity” will be able to be designated to a folder for storing full-length adult animations.

Hereinafter, a configuration will be discussed in which a user requests a search for folders stored in a shared folder of another information processor to receive a list of the searched folders and the list of the folders is displayed on an information processor of the user.

A transmitting unit 1204 also sends to a P2P server 1210 a search request to search for folders corresponding to a given category, and a receiving unit 1205 receives a list of the folders responsive to the search request from the P2P server 1210. In displaying the folder list so that the user of the information processor 1211 views the list, a control unit 1206 causes folders to be displayed in different shapes according to folders belonging to respective categories.

According to an embodiment of the present invention, the control unit 1206 may cause only folders belonging to some particular categories to be displayed in a different manner. For example, folders, which belong to an 19-years-or-older age limit category that can be used only by users over the age of 19, may be displayed in a red color rather than a yellow color for typical folders (on the contrary, folders belonging to “infant” category may be displayed as blue on the information processor receiving the search list). Further, the minimum age that can employ an age limit category may be displayed. FIG. 13 shows an example in which folders corresponding to a 19-years-or-older age limit category are displayed.

According to another embodiment of the present invention, the control unit 1206 may make folders corresponding to a given category not to be displayed on the information processor of the user from the beginning. For example, in the case where a folder corresponding to the 19-years-or-older age limit category is searched, it is not displayed on the information processor 1211 when the user of the information processor 1211 is under an age of 19 (user age information may be obtained when member subscription is made to receive the P2P service).

According to a further embodiment of the present invention, the aforementioned display manner may be different depending on the setup of a user who is storing a relevant folder in the shared folder of his/her information processor. For example, if users of two different information processors register and share folders corresponding to the 19-years-or-older age category in a shared folder of each information processor, it is possible to display to one user a folder belonging to the 19-years-or-older age limit category as shown in FIG. 13 regardless of the age of the user receiving a search list, and it is possible to make folders belonging to the 19-years-or-older age limit category not to be displayed on the information processor of a user under the age of 19 from the beginning.

Meanwhile, although the P2P service system 1200 according to this embodiment has been described in connection with the case where files are searched by category as a reference to which a folder corresponds, simultaneous searches using a file name or the like as well as retrieval on a category-by-category basis as a variant of this embodiment may be made.

Further, when registering folders in the shared folder on a category-by-category basis as in this embodiment, category information corresponding to the relay information processor 103 can be set more easily according to the sixth embodiment as described above. That is, it is convenient to use the same classification criterion for a category used upon registering folders and a category to which files to be relayed in the relay information processor belong.

According to the present invention, the P2P server may be configured of one or more servers. Further, the P2P server can be provided from P2P service companies and an information processor using a P2P service may function as the P2P server. At this time, an information processor functioning as the P2P server may be changed.

As described above, although the present invention has been described in connection with the specific embodiments and the drawings, the present invention is not limited to the embodiments and a variety of modifications and variations of the present invention may be made by those skilled in the art from such descriptions. Thus, the spirit and scope of the present invention should be construed based on only the appended claims, and all equivalent variations fall within the scope of the present invention.

### INDUSTRIAL APPLICABILITY

According to the present invention, since P2P service companies providing a P2P service can provide a variety of services capable of preferentially treating paid members as compared to free members, conversion from free members to paid members can be induced. Thus, revenue of the P2P service companies can be assured.

Further, the present invention can overcome several inconveniences caused due to the nature of the P2P during using the P2P service. With the present invention, it is possible to transmit and receive files between information processors when connection times of respective information processors are different from each other. Further, according to the present invention, it is possible to transmit and receive files between remote information processors by connecting to a P2P operating server using a mobile communication terminal.

In addition, with the present invention, it is possible to offer a P2P service interlocked with the community using information on the information processors subscribed to respective communities.

Further, with the present invention, it is possible to transmit and receive files to and from an information processor to which a direct connection is not allowed due to the existence of a firewall or the like, using a relay information processor. In particular, with the present invention, transmitted and received files can be stored in the relay information processor, and accordingly even the user of the information processor relaying file transmission and reception can obtain files belonging to a desired category.

1. A P2P service method, comprising the steps of: receiving a download request to download a predetermined file stored in a shared folder from another information processor; receiving member information including the type of a member and a holding point value held by the other information processor from the other information processor; determining, based on the member information, whether a user of the other information processor is a free member; if the user of the other information processor is the free member, comparing the holding point value to a file point value corresponding to the size of the file; and if the holding point value is larger than the file point value, transferring the file to the other information processor.

2. The method as claimed in claim 1, further comprising the step of: generating a control signal to decrease the holding point value corresponding to the user of the other information processor by the file point value.

3. The method as claimed in claim 1, further comprising the steps of: transferring the file to the other information processor if the user of the other information processor is a paid member; determining whether the user of a shared information processor holding the shared folder is a free member; and increasing a holding point value corresponding to the user of the shared information processor by the file point value if the user of the shared information processor is the free member.

4. A method of providing a P2P service in a collecting information processor including a collecting folder, comprising the steps of: permitting an upload request from another information processor to the collecting folder with respect to a predetermined file; receiving the file and storing the same in the collecting folder; receiving member information including the type of a member and a holding point value held by the other information processor from the other information processor; determining, based on the member information, whether the user of the other information processor is a free member; if the user of the other information processor is a paid member, determining whether the user of the collecting information processor is a free member; and generating a control signal to decrease a holding point value corresponding to the user of the collecting information processor by a file point value corresponding to the size of the file if the user of the collecting information processor is the free member.

5. The method as clamed in claim 4, further comprising the steps of: if the user of the other information processor is the free member, determining whether the user of the collecting information processor holding the collecting folder is the free member; and if the user of the collecting information processor is a paid member, generating a control signal to increase a holding point value corresponding to the user of the other information processor by a file point value corresponding to the size of the file.

6. The method as clamed in claim 4, further comprising the steps of: if the user of the other information processor is the free member, determining whether the user of the collecting information processor holding the collecting folder is the free member; and if the user of the collecting information processor is the free member, generating a control signal to decrease the holding point value corresponding to the user of the collecting information processor by the file point value corresponding to the size of the file.

7. A method of providing a P2P service in a first information processor, comprising the steps of: setting up the maximum simultaneous connection number of information processors that can be simultaneously connected to use the P2P service, to the first information processor; receiving a connection request to the first information processor from a second information processor; determining whether the number of information processors connected to the first information processor matches the maximum simultaneous connection number; if the number of the information processors connected to the first information processor matches the maximum simultaneous connection number, identifying whether a user of the second information processor is a paid member; identifying whether there is a free member among the users of the information processors connected to the first information processor; and if the user of the second information processor is a paid member and there is a free member among the users of the information processors connected to the first information processor, terminating the connection of the free member's information processor, and allowing the connection of the second information processor.

8. A method of providing a P2P service in a first information processor, comprising the steps of: setting up the maximum simultaneous connection number of information processors that can be simultaneously connected to use the P2P service, to a first information processor; receiving a connection request to the first information processor from a second information processor; determining whether the number of information processors connected to the first information processor matches the maximum simultaneous connection number; if the number of the information processors connected to the first information processor matches the maximum simultaneous connection number, identifying member class information of users of the information processors connected to the first information processor and the second information processor; and if there are lower order users having a lower membership class than that of the user of the second information processor among the users of the information processors connected to the first information processor, terminating connection of the lower order user's information processor and permitting the connection of the second information processor.

9. The method as claimed in claim 8, wherein the step of terminating the connection of the lower order user's information processor comprises the steps of: if there are a plurality of lower order users, discriminating the lowest order user having the lowest membership class among the lower order users; and blocking the connection of the lowest order user's information processor.

10. The method as claimed in claim 9, wherein the step of blocking the connection of the lowest order user's information processor comprises: if there are a plurality of the lowest order users, discriminating the last connected information processor among the lowest order users' information processors; and blocking the connection of the last connected information processor.

11. A method of providing a P2P service in a P2P server, comprising the steps of: if a second information processor is not connected to the P2P server, receiving a download request to download a file stored in the second information processor from a first information processor; storing the download request in a given storage device; receiving a connection request from the second information processor; if the first information processor is not connected to the P2P server and the download request to download the file stored in the second information processor to the first information processor is stored in the given storage device, downloading the file stored in the second information processor to the P2P server in response to the connection request from the second information processor; and transferring the file downloaded by the P2P server to the first information processor in response to the connection request from the first information processor.

12. A method of providing a P2P service in a mobile communication terminal, comprising the steps of: transmitting a connection request to a P2P server; transmitting a search request to search for files stored in a shared folder of an information processor of which the connection is established to the P2P server; receiving a search result from the P2P server responsive to the search request; selecting files among files contained in the search result; selecting a second information processor to which the selected files will be transferred; and transmitting a control signal for enabling the selected files to be sent to the second information processor.

13. A P2P service method, comprising the steps of: storing community information on users subscribed to communities on a community-by-community basis; establishing and providing shared channels corresponding to the communities, respectively; if an information processor establishes a connection to a P2P server, discriminating a community to which a user of the information processor is subscribed, based on the community information; and displaying information on the user of the information processor on a shared channel corresponding to the community to which the user of the information processor is subscribed.

14. A P2P service method, comprising the steps of: receiving a relay application to relay file transmission and reception between other information processors, and category information from a relay information processor; storing an IP address corresponding to the relay information processor and the category information in a relay database; if a first information processor attempts a direct connection to a second information processor and then fails the direct connection, receiving from the first information processor a request to transmit and receive files to and from the second information processor; receiving file category information to which files transmitted and received between the first and second information processors belong; searching for category information that matches the file category information from the relay database; and transmitting an IP address of the relay information processor corresponding to the searched category information to the first and second information processors.

15. A computer-readable recording medium on which a program is recorded, the program implementing the method as claimed in claim 1 on a computer.

16. A system for providing a P2P service in an information processor, comprising: an input unit for receiving one or more categories corresponding to a folder if the folder is registered on a shared folder of the information processor; a storage unit for storing one or more categories corresponding to the folder; a search unit for searching for folders stored in the storage unit and corresponding to a given category when receiving a search request to search for the folders corresponding to the given category from another information processor; and a transmitting unit for transmitting a list of the searched folders to the other information processor.

17. The system as claimed in claim 16, wherein the transmitting unit further transmits a search request to search for folders positioned in a shared folder of the other information processor and belonging to a given category, the system further comprises: a receiving unit for receiving the list of the folders from the other information processor in response to the search request; and a control unit for making the folders to be displayed in different shapes on a category-by-category basis when the list of the folders is displayed.

18. The system as claimed in claim 17, wherein the storage unit further stores user information including the age of the user of the information processor, if there exists a folder corresponding to an age limit category for limiting an use permissible age among the list of the folders, and the user of the information processor is determined to be of less than the use permissible age based on the user information, the control unit performs control so that the folder belonging to the age limit category is not displayed.
